(19) United States
(12) Patent Application Publication
(10) Pub. No.: US 2026/0086776 A1
(43) Pub. Date: Mar. 26, 2026

(54) METHOD AND APPARATUS FOR GENERATING BLOCKS OF CODE USING ARTIFICIAL INTELLIGENCE

(71) Applicant: AT&T Intellectual Property I, L.P., Atlanta, GA (US)

(72) Inventors: Purav Patel, Mt. Prospect, IL (US); Mital Patel, Wheeling, IL (US); Ajay Singh, Hillsborough, NJ (US); Geoff Redmond, Huntley, IL (US); Rajiv Sikdar, East Brunswick, NJ (US); Alan Xiao, Alpharetta, GA (US); Gregory Summers, Overland Park, KS (US); Sujana Narne, Aldie, TX (US)

(73) Assignee: AT&T Intellectual Property I, L.P., Atlanta, GA (US)

(21) Appl. No.: 18/891,606

(22) Filed: Sep. 20, 2024

(51) Int. Cl. G06F 8/35

(52) U.S. Cl. CPC G06F 8/35

(57) ABSTRACT

Aspects of the subject disclosure may include, for example, obtaining code data from a plurality of repositories that each include a particular domain-related code (e.g., network domain-related code); generating a NLP model based on the code data; receiving input (e.g., via an API or other technique) where the input includes a natural language statement from equipment of a programmer, and where the natural language statement indicating an intent of the programmer to generate a particular domain-specific code compatible with the particular domain-related code; generating, according to the intent of the programmer, a code block by applying the NLP model to the natural language statement; and providing the code block for presentation at the equipment of the programmer. Other embodiments are disclosed.

### FIELD OF THE DISCLOSURE

The subject disclosure relates to a method and apparatus for generating blocks of code using artificial intelligence.

### BACKGROUND

Network programming requires specialized knowledge and expertise in managing, configuring, and operating network-related tasks and resources. Traditional methods often involve manual coding and significant human intervention, which can be time-consuming and prone to errors. New network programmers typically need assistance from experienced developers to write domain-specific code, further complicating the process.

Existing solutions lack the capability to automate the generation of domain-specific code based on the programmer's intent. Current tools do not provide comprehensive support for multiple programming languages or the ability to dynamically adapt to changes in protocols and techniques. This gap highlights the need for a platform that can streamline the coding process, reduce human dependency, and enhance productivity for network programmers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a platform (e.g., an Artificial Intelligence/Machine Learning (AI/ML) platform) which can generate domain specific code (e.g., network domain) based on an intent of a developer, network programmer or other user. Other embodiments are described in the subject disclosure.

In one or more embodiments, the system and methodology can be applied to programming in the network domain, which can be different than regular programming, and which can provide any needed network domain expertise and understanding. In one or more embodiments, the system and methodology can avoid any new person working in this area to require some assistance from another experienced developer. In one or more embodiments, the system and methodology can behave as a developer assistant or facilitator, such as through use of an AI/ML platform that can automate and solve this problem without including or requiring another human. In one or more embodiments, while writing network domain specific code, the platform can automatically generate simple to complex network domain code blocks in some or all computer languages, such as java, python, c, c++, .net, golang, etc. In one or more embodiments, the system and methodology provides a tool that generates network domain intent-based code to help developers and network programmers.

In one or more embodiments, the system and methodology avoids the need to train and provide mentors to new network programmers to help them write network domain specific code. In one or more embodiments, the platform can automate a coding process and remove second person dependency via automated support using AI/ML. In one or more embodiments, the platform can scan some or all network domain related software code, which can be private and/or public code based on where the platform is in use. In one embodiment, after scanning code, the platform can group and tokenize keywords and generate an NLP (Natural Language Processing) based model. In one or more embodiments, the model can be served as an API/Microservice and can produce block(s) of network domain specific code with an input human language statements representative of a network programmer's coding intent.

In one or more embodiments, the system and methodology can automate the generation of network domain-specific code using AI and machine learning by providing a tool that can interpret natural language statements and can generate corresponding code blocks in multiple programming languages.

In one or more embodiments, the system and methodology provides AI/ML-based code generation. For example, the platform can leverage AI and ML to scan existing network domain-related code repositories, tokenize keywords, and create an NLP model. This model can then generate code blocks based on the programmer's intent which is expressed in natural language. In this example and throughout the disclosure the term programmer can include any user that is utilizing the platform, system or method regardless of their level of expertise or understanding of computer programming.

In one or more embodiments, the system and methodology provides multi-language support. For example, the exemplary embodiments can support the generation of code in various popular programming languages such as Java, Python, C, C++, .NET, and Golang. This multi-language capability can be important for accommodating the diverse coding environments used in network programming.

In one or more embodiments, the system and methodology provides network domain specificity. Unlike general-purpose code generation tools, in one or more embodiments the system and methodology can be specifically tailored for the network domain. For instance, the platform can generate code for tasks related to IP Address Management, Network Resource Management, Virtual Private Network(s) (VPN), Network Configuration, and more. This specialization ensures that the generated code is highly relevant and useful for network programmers.

In one or more embodiments, the system and methodology provides a dynamic and adaptive Application Programming Interface (API). For example, the platform can include an API that can dynamically adapt to changes in network protocols and techniques over time. This ensures that the generated code remains up-to-date with the latest network standards and practices.

In one or more embodiments, the system and methodology provides for a reduction of human dependency. For example, by automating the code generation process, the exemplary embodiments can reduce the need for mentorship and assistance from experienced network programmers. This can significantly speed up the onboarding process for new developers and improve overall productivity.

In one or more embodiments, the system and methodology provides Integrated Development Environment (IDE) Integration. For example, in one or more embodiments, the platform can be integrated as a plugin within various or popular IDEs, providing a seamless and user-friendly experience for network programmers. This integration allows developers to access the tool directly within their preferred coding environment.

In one or more embodiments, the system and methodology can use advanced AI/ML techniques for code generation, and support multiple programming languages, while dynamically adapting to changes in network protocols.

In one embodiment, the system for generating network domain-specific code can be implemented as a cloud-based service, where the code repositories are stored in a centralized cloud storage. This allows for scalable and efficient scanning of large volumes of network-related code data. The NLP model can be hosted on a cloud platform, enabling the NLP model to process natural language input statements from network programmers in real-time. The generated code blocks can then be delivered back to the programmer through a web-based interface or an API, ensuring accessibility from any location.

In another embodiment, the system can be integrated into an on-premises environment, where the code repositories are stored within an entity's internal network. This setup ensures that sensitive or proprietary code data remains within the organization's secure infrastructure. For example, the NLP model can be deployed on local servers, providing the same real-time code generation capabilities while maintaining data privacy and security. In one embodiment, the generated code blocks can be accessed through a local IDE plugin, allowing network programmers to seamlessly incorporate the tool into their existing workflows.

In a further embodiment, the system can support a hybrid approach, where public code repositories are scanned and processed in the cloud, while private code repositories are handled on-premises. This hybrid model leverages the scalability of cloud computing for public data while ensuring the security of private data. The NLP model can be designed to dynamically switch between cloud and on-premises processing based on the source of the code data, providing a flexible and adaptable solution for different organizational needs.

Additionally, the system can be configured to support various levels of user access and permissions. For instance, junior network programmers may have access to basic code generation features, while senior programmers and administrators can access advanced customization options and model training capabilities. This tiered access control ensures that the tool can be effectively utilized by users with different levels of expertise and responsibility within the organization.

Moreover, the system can incorporate feedback mechanisms to continuously improve the accuracy and relevance of the generated code blocks. In one or more embodiments, network programmers can provide feedback on the generated code, which can be used to refine the NLP model and enhance the performance of the NLP model over time. This iterative improvement process ensures that the system remains up-to-date with network protocols and techniques, providing high-quality code generation support for network programmers.

One or more aspects of the subject disclosure include a method. The method can include scanning, by a processing system including a processor, a plurality of repositories to collect code data, where the plurality of repositories includes network domain-related code, and where the plurality of repositories includes public and non-public repositories. The method can include preprocessing, by the processing system, the code data resulting in a structured dataset; and generating, by the processing system, an NLP model based on the structured dataset. The method can include receiving, by the processing system, input including a natural language statement from equipment of a programmer, where the natural language statement indicates an intent of the programmer to generate network domain-specific code. The method can include generating, by the processing system and according to the intent of the programmer, a code block by applying the NLP model to the natural language statement. The method can include providing, by the processing system, the code block for presentation at the equipment of the programmer.

One or more aspects of the subject disclosure include a non-transitory machine-readable medium, comprising executable instructions that, when executed by a processing system including a processor, facilitate performance of operations. The operations can include obtaining code data from a plurality of repositories, where each of the plurality of repositories includes a particular domain-related code. The operations can include generating an NLP model based on the code data. The operations can include receiving input via an API, where the input includes a natural language statement from equipment of a programmer, and where the natural language statement indicates an intent of the programmer to generate a particular domain-specific code compatible with the particular domain-related code. The operations can include generating according to the intent of the programmer, a code block by applying the NLP model to the natural language statement, where the generating the code block comprises generating multiple versions of the code block, and where the multiple versions of the code block are at least one of applicable to different vendor equipment, in different programming languages, applicable to different service providers, or a combination thereof. The operations can include providing the multiple versions of the code block for presentation at the equipment of the programmer.

One or more aspects of the subject disclosure include a device comprising: a processing system including a processor; and a memory that stores executable instructions that, when executed by the processing system, facilitate performance of operations. The operations can include providing input to a server, where the input includes a natural language statement, and where the natural language statement indicates an intent by a programmer to generate network domain-specific code. The operations can include receiving, from the server, code block, where the code block is generated based on applying an NLP model to the natural language statement, where the NLP model is generated from training based on code data, and where the code data is scanned from a plurality of repositories that include network domain-related code. The operations can include providing, to the server, at least one of feedback data, additional code data, or a combination thereof, where the feedback data is associated with an analysis of the code block, where the additional code data includes the code block, and where the NLP model is adjusted based on at least one of the feedback data, the additional code data, or a combination thereof resulting in an adjusted NLP model.

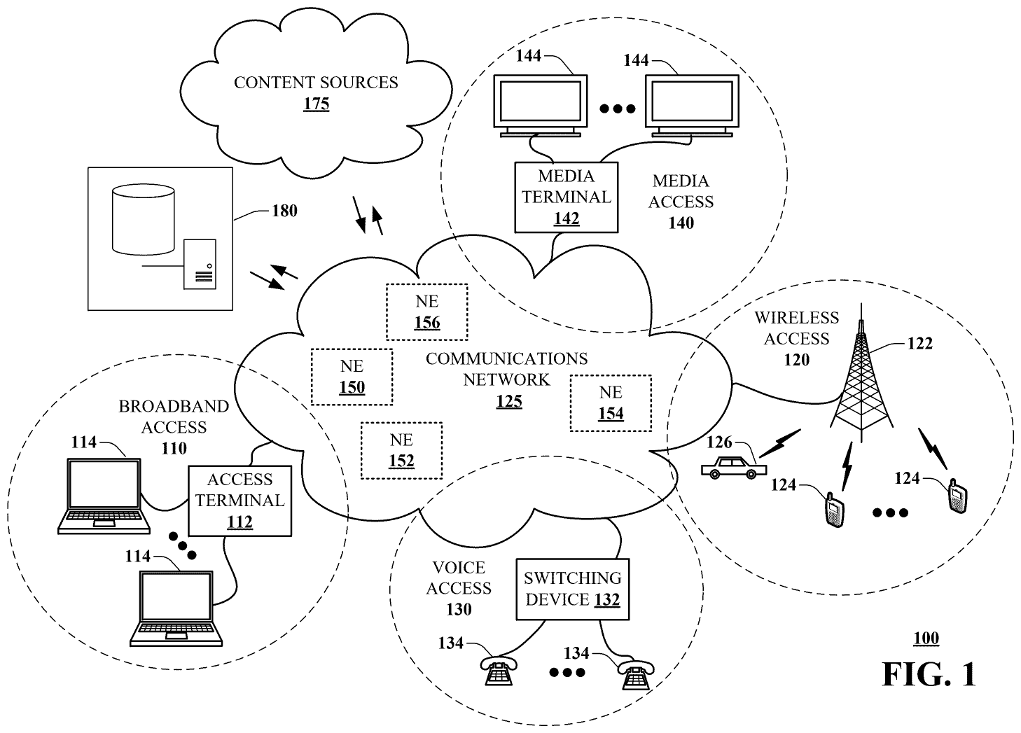

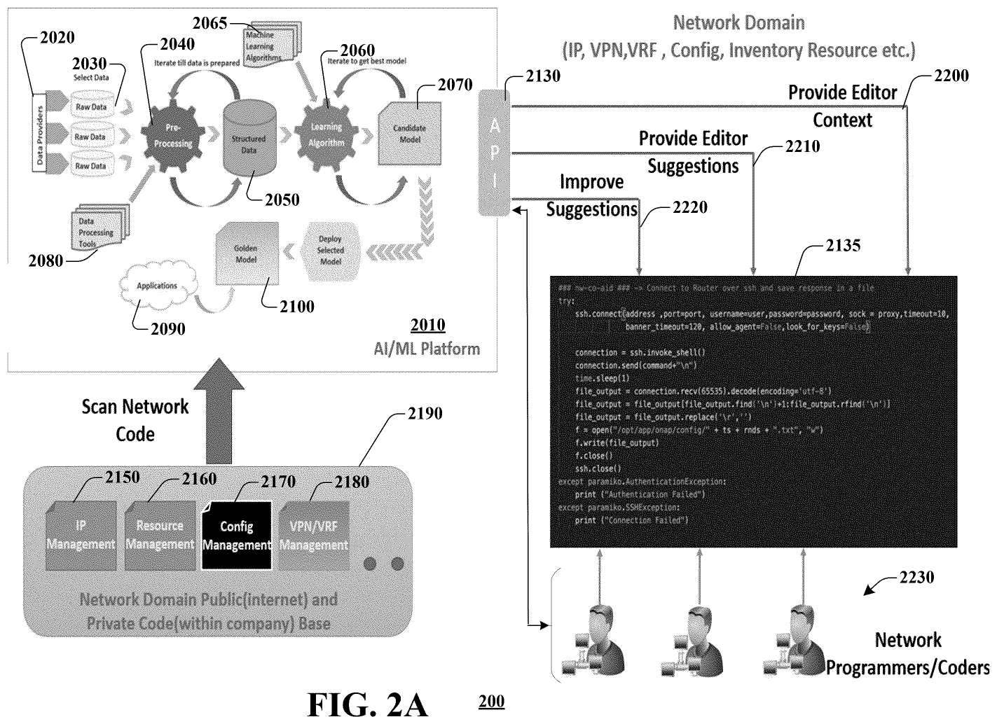

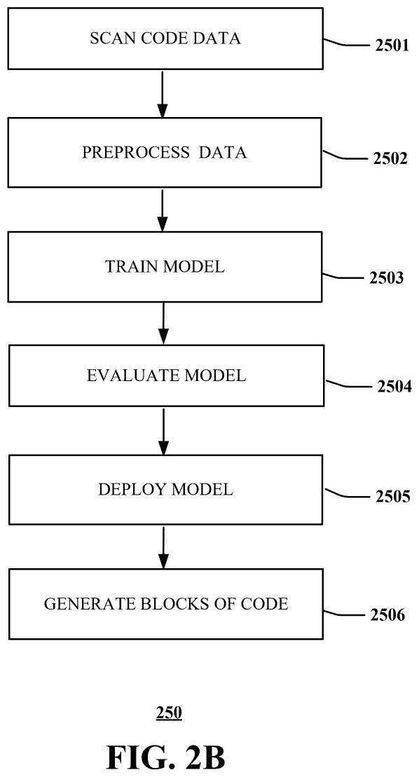

Referring now to FIG. 1, a block diagram is shown illustrating an example, non-limiting embodiment of a system 100 in accordance with various aspects described herein. System 100 can include an AI/ML platform 180 (which can be similar to platform 2010 described with respect to FIG. 2A) which can generate blocks of code for use in various domains, such as a network coding domain. In one or more embodiments, the platform 180 can receive natural language inputs, such as from developers, programmers or other users, that are developing code and/or a service for use with or by a network. In one or more embodiments, the platform 180 can provide suggestions and recommendations, as well as predict network-related code block based on the user intentions (e.g., desired or intended functionality that is input by the user). In one embodiment, the platform 180 can scan some or all network domain related code, such as IP Address Management, Network Resource Management, VPN, Network Configuration, and so on. Based on the code scan, an AI/ML model can be generated or otherwise trained. In one embodiment, the model can be hosted as an API which can receive, retrieve or otherwise obtain input as different language statements and can capture, determine or discern intent of the user/coder. As an example, the model can then be utilized by the platform 180 to generate various corresponding code, such as in different computer programming languages such as java, c, c++, python, .net based code blocks, and so forth. In one or more embodiments, the user can select the generated code language(s). In one or more embodiments, the system and methodology described herein can support different human language and can support multiple programming languages. In one or more embodiments, the platform 180 can be used for various types of code, which may or may not be network domain related code.

For example, system 100 can facilitate in whole or in part obtaining code data from a plurality of repositories that each include a particular domain-related code (e.g., network domain-related code); generating a NLP model based on the code data; receiving input (e.g., via an API or other technique) where the input includes a natural language statement from equipment of a programmer, and where the natural language statement indicates an intent of the programmer to generate a particular domain-specific code compatible with the particular domain-related code; generating, according to the intent of the programmer, a code block by applying the NLP model to the natural language statement; and providing the code block for presentation at the equipment of the programmer.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 2A is a block diagram illustrating an example, non-limiting embodiment of a system 200 functioning within the communication network of FIG. 1 in accordance with various aspects described herein. System 200 can generate network domain-specific code using an AI/ML platform 2010. For example, the system 200 allows for scanning of network code from public and/or private repositories, as indicated by the scan network code block 2190. This block 2190 can include various network management domains such as IP Management 2150, Resource Management 2160, Config Management 2170, and VPN/VRF Management 2180. The scanned network code from block 2190 can serve as part of or the entirety of the raw data input 2030 for the AI/ML platform. It should be understood that as other management domains are created (e.g., according to advances in technology, changes in the 3GPP standard and so forth), the scan network code block 2190 can be adjusted or updated to access such code for scanning. It should be understood that while system 200 is being illustrated for network domain coding, the AI/ML platform and system 200 can be adapted for other domains, particularly domains that have unique coding requirements, protocols and/or standards, such as robotics, IoT devices, self-driving vehicles, etc.

The platform 2010 can function as a core component of the system 200 and can operate or be executed in a centralized or distributed fashion including in the Cloud, on one or more servers, via virtual machines, via microservices, and in various other configurations of hardware and functionality/software. In one or more embodiments, platform 2010 can include various sub-components or functionality including access to data providers 2020, which provide raw data 2030 (e.g., public and/or private), such as in text format including code, articles, books, etc. that can be used for training an NPL particularly in the area of generating software code. Platform 2010 can provide for pre-processing 2040, which may involve selecting and preparing the raw data 2030 (and any other information being used for training such as network code 2190) using data processing tools 2080 to convert the raw data into structured data 2050. Platform 2010 can include a learning module or algorithm 2060, which can make use of one or combinations of various types of ML/AI algorithms 2065 and which can be iteratively applied to or trained by the structured data 2050 to develop a candidate model(s) 2070.

Candidate model(s) 2070 can be evaluated by the platform 2010 to determine a best or selected model, which can be subsequently deployed as the golden model 2100 (e.g., an NLP model), and the platform 2010 can make use of applications 2090, which utilize the golden model for code generation. The factors and tools that are utilized for selecting the golden model can vary and can be based on accuracy, efficiency, etc.

The platform 2010 can include or interface with an API 2130 that enables interaction or access to functionality of the golden model 2100. As an example, the API 2130 can allow network programmers to input natural language statements and to receive corresponding code block(s) (an example of which is illustrated in the editor 2135). The API 2130 can provide several other functionalities including editor context 2200, which provides context to the editor 2135 based on the input from the network programmer; editor suggestions 2210, which offers suggestions to improve the generated code; and improve suggestions 2220, which can continuously improve its suggestions based on feedback (e.g., from the programmers or from other sources including AI/ML models evaluating the performance of the platform 2010) and updates.

The generated code block can be presented or displayed such as in the editor 2135, where network programmers can review and use it such as for building their own code using at least in part the blocks of code. The editor 2135 illustrates an example of generated code for connecting to a router over SSH and saving the response in a file. This code is generated based on the natural language input provided by the network programmer. FIG. 2A further illustrates the network programmers or coders 2230 who interact with the platform 2010. They can provide natural language input, review the generated code, and/or offer feedback to improve the system 200. For example, feedback can be used to refine the model 2100 and/or the candidate models 2070 (e.g., where a next generation golden model is to be deployed) and can enhance the code generation process, ensuring that the platform 2010 remains up-to-date with the latest network protocols and techniques.

Platform 2010 can perform grouping and tokenizing keywords in preparing text data for an NLP model. This can include transforming raw text into a structured format that can be effectively used by machine learning algorithms. For example, the platform 2010 can perform tokenization by breaking down text into smaller units (i.e., tokens) which can be words, phrases, or characters, depending on the level of granularity that is applied. For example, tokenization by platform 2010 can include splitting a sentence into individual words.

Platform 2010 can group keywords by identifying and categorizing important terms or phrases that are relevant to the specific domain or context of the text, such as in the example of network domain coding, identifying network-related terms and phrases such as “IP Address Management,” “VPN,” “Network Configuration,” etc. By grouping these keywords, the platform 2010 facilitates understanding the context and intent behind the text, which leads to generating accurate and relevant code blocks. For example, if the input text contains the phrase “configure VPN,” the platform 2010 can recognize “VPN” as a keyword related to Virtual Private Network management and generate appropriate code snippets for VPN configuration.

Once the platform 2010 performs text tokenizing and keyword grouping, the NLP model can use this structured data to perform various tasks such as intent recognition which includes understanding the user's intent based on the keywords and context. For example, recognizing that the user wants to configure a VPN. The NLP model can also perform contextual analysis by analyzing the relationships between tokens and keywords to understand the overall context of the text. This helps in generating more accurate and relevant code snippets. The NLP model can also perform code generation by using the identified keywords and context to generate appropriate code blocks. For example, generating Python code for configuring a VPN based on the input text “configure VPN.” The NLP model can also perform improvement of model accuracy by grouping and tokenizing keywords which assist in creating a more accurate and robust NLP model by providing it with structured and relevant data. This improves the model's ability to understand and generate code based on natural language input.

The example of FIG. 2A illustrates platform 2010 being utilized for generating blocks of relevant code for network domain coding, which includes software code that is specifically designed to manage, configure, and operate network-related tasks and resources. This type of coding is distinct from general-purpose programming because it requires specialized knowledge of network protocols, configurations, and management practices.

Platform 2010 can be applied to generate code blocks for network domain coding which includes tasks such as:
IP Address Management: Writing code to allocate, manage, and track IP addresses within a network. This includes tasks like subnetting, IP address assignment, and IP address conflict resolution.
Network Resource Management: Developing software to manage network resources such as routers, switches, firewalls, and other network devices. This includes tasks like device configuration, monitoring, and maintenance.
VPN Management: Creating code to establish, configure, and manage VPNs. This involves tasks like setting up secure tunnels, managing encryption keys, and ensuring secure data transmission.
Network Configuration: Writing scripts and programs to configure network devices and services. This includes tasks like setting up routing protocols, configuring Access Control Lists (ACLs), and managing network policies.
Inventory and Resource Tracking: Developing software to keep track of network assets, including hardware and software components. This involves tasks like maintaining an inventory of network devices, tracking their status, and managing their lifecycle.
Automation and Orchestration: Creating code to automate repetitive network management tasks and orchestrate complex network operations. This includes tasks like automated device provisioning, network topology changes, and performance optimization.

Platform 2010 can behave as a bridge or facilitator for a network programmer or other developer because it accepts natural language inputs and can apply a deep understanding of networking concepts, protocols (such as TCP/IP, BGP, OSPF), and standards when the coding block (representative of the natural language input) is generated. Platform 2010 also allows the resulting code blocks to be compatible with various network management tools and APIs provided by network device manufacturers. Platform 2010 can adjust natural language inputs into network domain coding that provides for efficient, reliable, and secure operation of network infrastructure, which can be within the context of large-scale enterprise or service provider networks.

Platform 2010 can be utilized for generating coding blocks for developers or programmers (e.g., according to natural language inputs) that facilitate functions of IP Address Management, Network Resource Management, VPN, and Network Configuration including:
IP Address Allocation: Assigning IP addresses to devices and ensuring that each device has a unique address.
Subnetting: Dividing a larger IP network into smaller sub-networks to improve management and security.
IP Address Tracking: Monitoring and recording the usage of IP addresses to prevent conflicts and ensure efficient utilization.
IP Address Conflict Resolution: Detecting and resolving conflicts where two devices are assigned the same IP address.
DNS and DHCP Integration: Coordinating with Domain Name System (DNS) and Dynamic Host Configuration Protocol (DHCP) services to automate IP address assignment and resolution.
Device Configuration: Setting up and maintaining the configuration of network devices to ensure they operate correctly and efficiently.
Resource Allocation: Assigning network resources to different services and applications based on demand and priority.
Monitoring and Maintenance: Continuously monitoring the performance and health of network devices and performing regular maintenance to prevent failures.
Capacity Planning: Analyzing current resource usage and predicting future needs to ensure the network can handle growth and increased demand.
Fault Management: Detecting, diagnosing, and resolving network issues to minimize downtime and service disruptions.
VPN Setup: Establishing VPN connections between remote sites or users and the central network.
Encryption Management: Configuring and managing encryption protocols to ensure data transmitted over the VPN is secure.
Authentication: Implementing authentication mechanisms to verify the identity of users and devices connecting to the VPN.
Access Control: Defining and enforcing policies that control what resources VPN users can access.
Performance Monitoring: Monitoring the performance of VPN connections to ensure they meet required service levels.
Troubleshooting: Identifying and resolving issues that affect VPN connectivity and performance.
Routing Configuration: Setting up routing protocols (e.g., BGP, OSPF) to ensure data packets are efficiently forwarded through the network.
Access Control Lists: Defining rules that control the flow of traffic based on IP addresses, protocols, and ports to enhance security.
Quality of Service (QoS): Configuring QoS policies to prioritize certain types of traffic and ensure reliable performance for critical applications.
Network Policies: Implementing policies that govern network behavior, such as bandwidth limits, traffic shaping, and security measures.
Device Provisioning: Automating the setup and configuration of new network devices to streamline deployment and reduce manual effort.
Firmware and Software Updates: Managing updates to device firmware and software to ensure they are running the latest, most secure versions.

FIG. 2B depicts an illustrative embodiment of a method 250 in accordance with various aspects described herein. Method 250 can be utilized for generating code blocks (e.g., network domain-specific code) using an AI/ML platform (e.g., platform 2010). The method 250 can be implemented by the platform 2010, which interacts with various components including network code repositories, an API or other access mechanism, and network programmers or coders. The example of method 250 will be described with respect to network domain coding, but it should be understood that method 250 can be applied to generate code blocks, such as based on natural language inputs, for various other domains, systems, services, technologies, processes, and so forth.

At 2501, network code can be obtained and scanned. For example, the source of the code can be public and/or private repositories. In one embodiment, the repositories can be of a single service provider and in other embodiments the repositories can be associated with multiple service providers. For example, the network code can include IP management code, resource management code, configuration management code, and VPN/VRF management code. The scanning of such code provides platform 2010 with access to a comprehensive dataset for analysis. Other types of data can be scanned or otherwise obtained for AI training including text, articles, books, and so forth.

At 2502, the scanned network code data (and any other data being used for training) can be preprocessed. This can include selecting raw data and using data processing tools to prepare the data for further analysis. As an example, the preprocessing can convert the raw data into structured data, which can facilitate application of subsequent machine learning processes.

At 2503, a candidate model(s) can be trained. For example, the platform 2010 can apply a learning algorithm to the structured data. For instance, the learning algorithm can apply various ML/AI techniques for training and learning including iterating over the structured data to develop a candidate model(s). This can facilitate training the AI/ML platform to understand and generate domain-specific code (e.g., network domain) based on the input data.

At 2504, the candidate model can be evaluated to determine or select a desired model. This can involve an iterative evaluation process utilizing various ML/AI tools which can also include feedback and analysis (e.g., by humans and/or by ML/AI performance and accuracy tools) to select an accurate and effective model. The selected model can then be deployed as the golden model, which can be used by the platform 2010 for generating blocks of code.

With a golden model now available for use, the method 250 continues to 2505, whereby an API provides access and interaction with the golden model. For example, the API allows network programmers (which can include any user that is utilizing the platform) to input natural language statements and receive corresponding code blocks. In one embodiment, the API can also provide editor context and/or suggestions to improve the generated blocks of code.

At 2506, the platform 2010 can generate code blocks based on the natural language input from network programmers, which can be presented or displayed in an editor, where programmers can review and use the generated code. In one embodiment, the platform 2010 can provide suggestions for code improvements and/or can dynamically update the NLP model to adapt to changes in network protocols and techniques. For example, the platform 2010 can receive and incorporate feedback from network programmers to refine the NLP model and enhance the code generation process. This iterative improvement ensures that the platform remains up-to-date and continues to provide high-quality code generation support.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As a non-limiting example, the AI/ML platform can take the statement “Generate ssh python code to show config” and produce the following output:
ssh. connect(address, port=port, username=user, password=password, sock=proxy, timeout=10, banner_timeout=120, allow_agent=False, look_for_keys=False) connection=ssh.invoke_shell( )
connection.send(“show config \n”)
file_output=connection. recv(65535). decode(encoding='utf-8′)
ssh.close( ).

In one or more embodiments, the blocks of code generated by the AI/ML platform can be multiple versions of the code that can be used with different vendor equipment that is being supplied to a service provider.

In one or more embodiments, the NLP model can be trained based on particular domain code data (e.g., network domain code) of different service providers. In this example, the blocks of code that are generated can be multiple versions that are each specific to a particular service provider.

In one or more embodiments, updates or modification to vendor equipment (including vendor software) and/or revisions to particular standards or other regulations (e.g., 3GPP standard) can be monitored by the platform to account for needed changes to the NLP model and the resulting generated blocks of code. In one embodiment, AI can be utilized to predict needed changes to blocks of code based on updates or modification to vendor equipment (including vendor software) and/or revisions to particular standards or other regulations (e.g., 3GPP standard).

In one or more embodiments, the functionality described herein via the AI/ML platform can be provided via an API, via a plug-in, or utilizing another delivery/access technique or technology.

In one or more embodiments, as programmers receive blocks of code from the platform and generate code therefrom, the programmers can provide the code back to the platform to better train the NPL model. This training can generate NPL models that are to be exclusively used by the programmer (or programmer's affiliated entity) or to be used by other programmers not affiliated with the programmer's entity.

In one or more embodiments, the repositories can have various access levels which may allow or prohibit use of certain code for training the NPL model. In one or more embodiments, programmers that request and receive blocks of code via the AI/ML platform may or may not authorize that code (or code built therefrom) to be used for training/revisions to the NPL model.

In one or more embodiments, models trained with a programmer's code can be limited for use by that programmer or entities authorized by the programmer.

In one or more embodiments, multiple NPL models can be trained based on different datasets which are distinguishable along different categories such as private vs public models.

In one or more embodiments, user profiles can be utilized to manage use of the platform, provide security, and/or limit access to private datasets or information. For example, a user profile can be accessed whenever a user is interacting with the platform (e.g., providing a natural language input to generate a block of code in a particular domain). In one embodiment, the types of input and/or domain code being sought can be determined and compared to the user profile to detect whether the user is authorized to be seeking this particular information. In one or more embodiments, the user profile can be applied to limit users to certain areas of code, such as providing blocks of code in the area of IP management but not providing blocks of code in the area of authentication based on the user's access level or user's approved coding area which can be defined by the user profile. Other techniques for safeguarding blocks of code can also be implemented.

In one or more embodiments, feedback data can include evaluation, adjustments and/or commentary on blocks of code by human, machine or both. The evaluation or analysis can be based on accuracy with respect to intent of the programmer, effectiveness of the generated code, compatibility with programmer's code, and so forth.

In one or more embodiments, the AI/ML platform described herein can be utilized as a tool that would help developers speed up their process of writing code. In one or more embodiments, the platform can be UI-based and/or IDE plugin-based. For instance, the plugin can work directly within the network programmer's IDE.

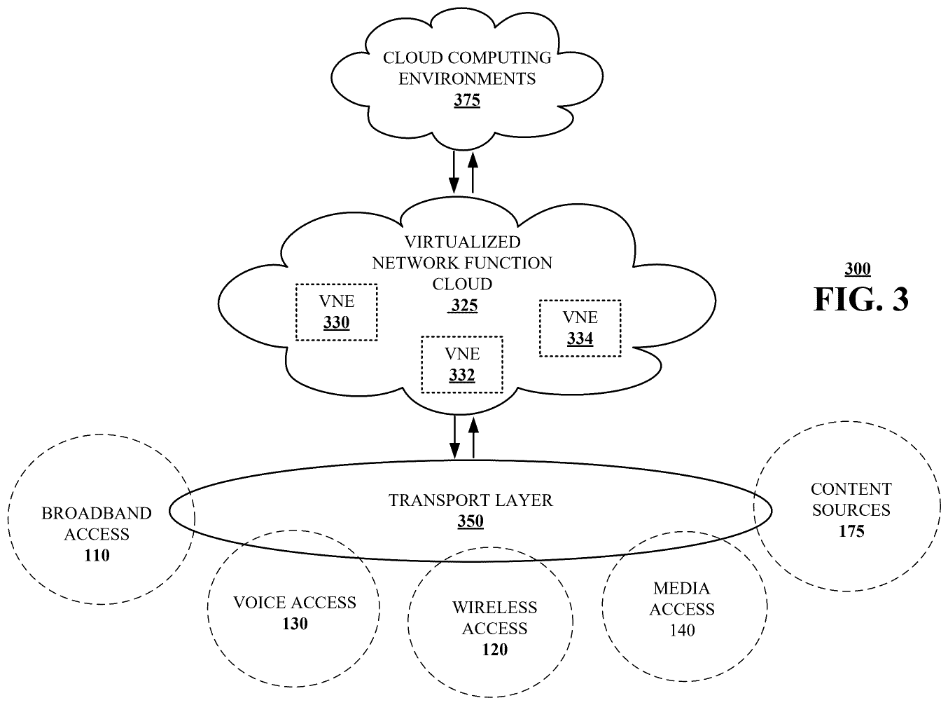

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, and 3.

For example, virtualized communication network 300 can facilitate in whole or in part obtaining code data from a plurality of repositories that each include a particular domain-related code (e.g., network domain-related code); generating an NLP model based on the code data; receiving input (e.g., via an API or other technique) where the input includes a natural language statement from equipment of a programmer, and where the natural language statement indicates an intent of the programmer to generate a particular domain-specific code compatible with the particular domain-related code; generating, according to the intent of the programmer, a code block by applying the NLP model to the natural language statement; and providing the code block for presentation at the equipment of the programmer.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers - each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

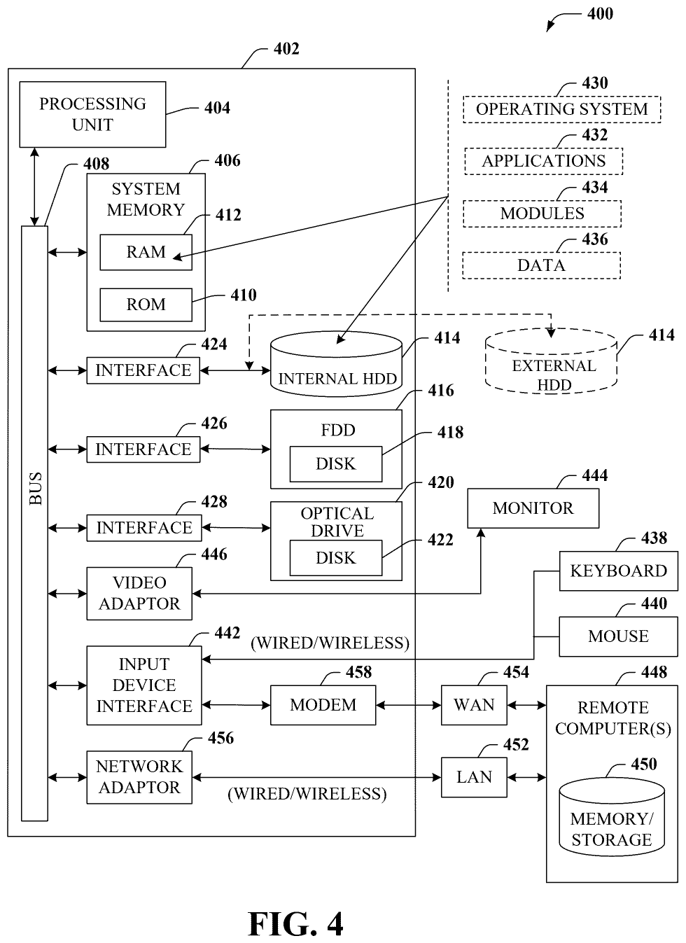

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software.

For example, computing environment 400 can facilitate in whole or in part obtaining code data from a plurality of repositories that each include a particular domain-related code (e.g., network domain-related code); generating an NLP model based on the code data; receiving input (e.g., via an API or other technique) where the input includes a natural language statement from equipment of a programmer, and where the natural language statement indicates an intent of the programmer to generate a particular domain-specific code compatible with the particular domain-related code; generating, according to the intent of the programmer, a code block by applying the NLP model to the natural language statement; and providing the code block for presentation at the equipment of the programmer.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

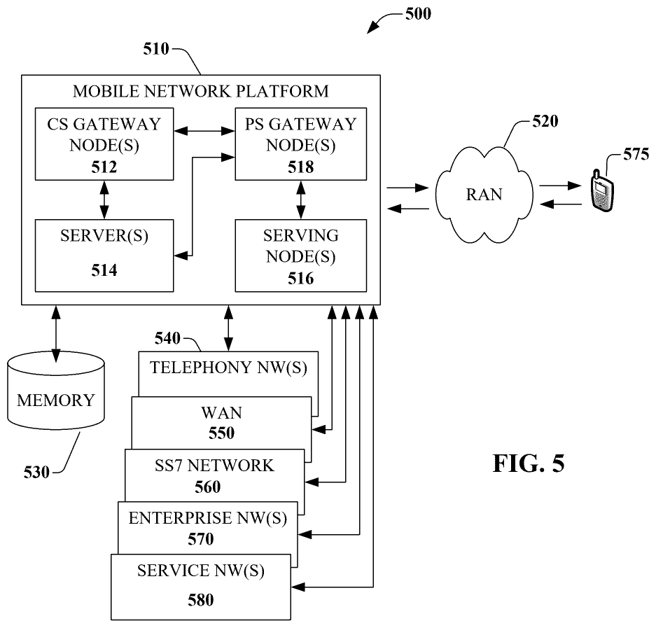

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part obtaining code data from a plurality of repositories that each include a particular domain-related code (e.g., network domain-related code); generating an NLP model based on the code data; receiving input (e.g., via an API or other technique) where the input includes a natural language statement from equipment of a programmer, and where the natural language statement indicates an intent of the programmer to generate a particular domain-specific code compatible with the particular domain-related code; generating, according to the intent of the programmer, a code block by applying the NLP model to the natural language statement; and providing the code block for presentation at the equipment of the programmer.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

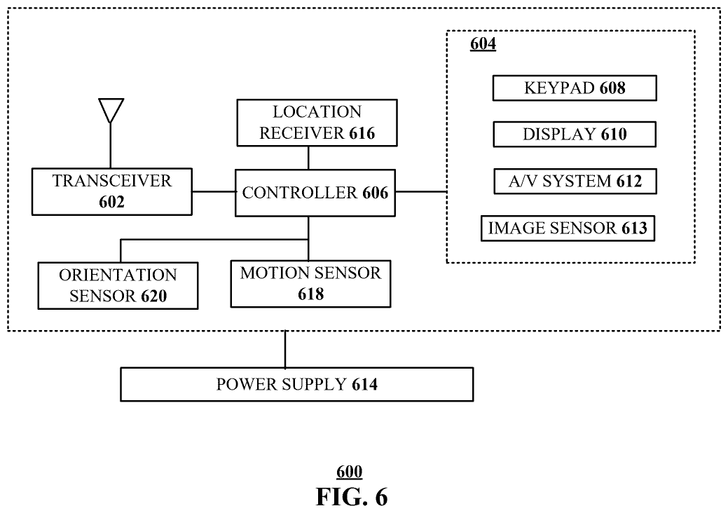

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125.

For example, computing device 600 can facilitate in whole or in part obtaining code data from a plurality of repositories that each include a particular domain-related code (e.g., network domain-related code); generating an NLP model based on the code data; receiving input (e.g., via an API or other technique) where the input includes a natural language statement from equipment of a programmer, and where the natural language statement indicates an intent of the programmer to generate a particular domain-specific code compatible with the particular domain-related code; generating, according to the intent of the programmer, a code block by applying the NLP model to the natural language statement; and providing the code block for presentation at the equipment of the programmer.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data s torage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method comprising:
scanning, by a processing system including a processor, a plurality of repositories to collect code data, wherein the plurality of repositories includes network domain-related code, wherein the plurality of repositories includes public and non-public repositories;
preprocessing, by the processing system, the code data resulting in a structured dataset;
generating, by the processing system, a Natural Language Processing (NLP) model based on the structured dataset;
receiving, by the processing system, input including a natural language statement from equipment of a programmer, the natural language statement indicating an intent of the programmer to generate network domain-specific code;
generating, by the processing system and according to the intent of the programmer, a code block by applying the NLP model to the natural language statement; and
providing, by the processing system, the code block for presentation at the equipment of the programmer.

2. The method of claim 1, comprising:
receiving, by the processing system, feedback data from the equipment of the programmer, the feedback data being associated with an analysis of the code block by the programmer; and
adjusting, by the processing system, the NLP model based on the feedback data resulting in an adjusted NLP model.

3. The method of claim 2, comprising:
receiving, by the processing system, a second input including a second natural language statement from the equipment of the programmer, the natural language statement indicating a second intent of the programmer to generate second network domain-specific code;
generating, by the processing system and according to the second intent of the programmer, a second code block by applying the adjusted NLP model to the second natural language statement; and
providing, by the processing system, the second code block for presentation at the equipment of the programmer.

4. The method of claim 1, comprising:
receiving, by the processing system, additional code data that includes the code block;
scanning, by the processing system, the additional code data; and
generating, by the processing system, an additional NLP model based on at least a portion of the structured dataset and at least a portion of the additional code data.

5. The method of claim 4, comprising:
receiving, by the processing system, a second input including a second natural language statement from the equipment of the programmer, the natural language statement indicating a second intent of the programmer to generate second network domain-specific code;
generating, by the processing system and according to the second intent of the programmer, a second code block by applying the additional NLP model to the second natural language statement; and
providing, by the processing system, the second code block for presentation at the equipment of the programmer.

6. The method of claim 5, wherein use of the additional NLP model is limited to an entity associated with the programmer or any entity authorized by the programmer.

7. The method of claim 1, wherein the generating the code block comprises generating multiple versions of the code block.

8. The method of claim 7, wherein the multiple versions of the code block are applicable to different vendor equipment.

9. The method of claim 7, wherein the multiple versions of the code block are in different programming languages.

10. The method of claim 7, wherein the multiple versions of the code block are applicable to different communications service providers.

11. The method of claim 1, comprising:
obtaining, by the processing system, information indicating a revision to a 3GPP standard; and
adjusting, by the processing system, the NLP model based on the information resulting in an adjusted NLP model.

12. The method of claim 1, comprising:
obtaining, by the processing system, information indicating a change to a vendor equipment; and
adjusting, by the processing system, the NLP model based on the information resulting in an adjusted NLP model.

13. The method of claim 1, further comprising providing, by the processing system to the equipment of the programmer, suggestions for code improvements based on the code block.

14. The method of claim 1, wherein the providing the code block comprises integrating, by the processing system, the code block into an Integrated Development Environment (IDE) used by the programmer.

15. A non-transitory machine-readable medium, comprising executable instructions that, when executed by a processing system including a processor, facilitate performance of operations, the operations comprising:
obtaining code data from a plurality of repositories, wherein each of the plurality of repositories includes a particular domain-related code;
generating a Natural Language Processing (NLP) model based on the code data;
receiving input via an Application Programming Interface (API), the input including a natural language statement from equipment of a programmer, the natural language statement indicating an intent of the programmer to generate a particular domain-specific code compatible with the particular domain-related code;
generating according to the intent of the programmer, a code block by applying the NLP model to the natural language statement, wherein the generating the code block comprises generating multiple versions of the code block, and wherein the multiple versions of the code block are at least one of applicable to different vendor equipment, in different programming languages, applicable to different service providers, or a combination thereof; and
providing the multiple versions of the code block for presentation at the equipment of the programmer.

16. The non-transitory machine-readable medium of claim 15, wherein the plurality of repositories includes public and non-public repositories, and wherein the particular domain-related code is a network domain-related code.

17. The non-transitory machine-readable medium of claim 15, wherein the operations further comprise:
receiving feedback data from the equipment of the programmer, the feedback data being associated with an analysis of the code block by the programmer; and
adjusting the NLP model based on the feedback data resulting in an adjusted NLP model.

18. The non-transitory machine-readable medium of claim 15, wherein the operations further comprise:
receiving additional code data that includes the code block;
scanning the additional code data; and
generating an additional NLP model based on at least a portion of the code data and at least a portion of the additional code data.

19. A device, comprising:
a processing system including a processor; and
a memory that stores executable instructions that, when executed by the processing system, facilitate performance of operations, the operations comprising:
providing input to a server, the input including a natural language statement, the natural language statement indicating an intent by a programmer to generate network domain-specific code;
receiving, from the server, code block, wherein the code block is generated based on applying an NLP model to the natural language statement, wherein the NLP model is generated from training based on code data, wherein the code data is scanned from a plurality of repositories that include network domain-related code; and
providing, to the server, at least one of feedback data, additional code data, or a combination thereof, wherein the feedback data is associated with an analysis of the code block, wherein the additional code data includes the code block, and wherein the NLP model is adjusted based on at least one of the feedback data, the additional code data, or a combination thereof resulting in an adjusted NLP model.

20. The device of claim 19, wherein use of the adjusted NLP model is limited to an entity associated with the programmer or any entity authorized by the programmer.
